(19) United States
(12) Patent Application Publication
(10) Pub. No.: US 2019/0174685 A1
(43) Pub. Date: Jun. 13, 2019

(54) SPLICED GUARDRAIL CONVENIENT TO DISASSEMBLE AND ASSEMBLE

(71) Applicants: Jia WANG, Shenzhen (CN); Jianzhuo YANG, Shenzhen (CN)

(72) Inventors: Jia WANG, Shenzhen (CN); Jianzhuo YANG, Shenzhen (CN)

(21) Appl. No.: 16/217,173

(22) Filed: Dec. 12, 2018

(30) Foreign Application Priority Data
Dec. 13, 2017 (CN) 201711332002.0
Dec. 13, 2017 (CN) 201721740997.X

(51) Int. Cl. A01G 9/28; A01K 63/00; F16M 11/22

(52) U.S. Cl. CPC A01G 9/28; F16M 2200/08; F16M 11/22; A01K 63/006

(57) ABSTRACT

A spliced guardrail convenient to disassemble and assemble comprises a plurality of supporting members. Each supporting member comprises an arc-shaped coaming, a shaft sleeve and a shaft arranged at the lower end of each arc-shaped coming, two supporting feet extending from the inner wall of each arc-shaped coaming, and first adjusting pieces mounted at the adjacent edge parts of the two supporting feet. An included angle of the two supporting feet and the radian of each arc-shaped coming can be adjusted by stirring the first adjusting pieces. The plurality of supporting members is sequentially spliced into one guardrail capable of being matched with the shape of an internally-arranged product, and the adjacent supporting members are movably connected through the corresponding shafts and shaft sleeves. The supporting members and the adjusting pieces are standard components, can be spliced to assemble guardrails in different shapes.

### FIELD OF THE INVENTION

The present invention relates to a spliced guardrail convenient to disassemble and assemble. The spliced guardrail may be spliced by a plurality of supporting members into various shapes, and can serve as a decorative guardrail for product exhibition and flower and plant exhibition in exhibition places, and for garden flowers, or as a supporting frame for flexible fish tanks in various shapes.

### BACKGROUND OF THE INVENTION

In general, decorative guardrails for flowers, product exhibition guardrails and aquarium frames are of mostly fixed shapes, and are easily damaged when they are moved and reused. In some occasions, such as product exhibition places, courtyards, etc., it is often necessary to provide decorative guardrails in various shapes that are adapted to use environments, and shapes and sizes of the placement locations, and the cost can be increased if guardrails in fixed shapes are provided in these occasions.

A foldable PVC plastic transparent fish tank is made up of a combination of a flexible tank wall and a flexible tank bottom and is formed into fish tanks in various shapes adapted to the environments after being injected with water. Since the tank body is flexible, a supporting frame adapted to the shape of the fish tank is required to auxiliarily support the fish tank to maintain the design shape of the fish tank. The shape and size of the flexible fish tank vary depending on different use places and placement locations. If the frame in a fixed shape is used, not only the manufacturing cost is increased, but also the storage and transportation are inconvenient. The spliced supporting frame that can be used for foldable plastic fish tanks in various shapes has not been disclosed in relevant literatures.

### SUMMARY OF THE INVENTION

In order to solve the above problems in the prior art, the invention provides a spliced guardrail convenient to disassemble and assemble. The spliced guardrail is spliced and surrounded by a plurality of supporting members into a guardrail that is adapted to the shape of a built-in product. The present invention provides a supporting member for making the spliced guardrail at the same time.

A spliced guardrail easy to disassemble and assemble comprises:

a plurality of supporting members; each supporting member comprises an arc-shaped coaming; a first supporting foot and a second supporting foot which extend inwards respectively from two edges of the inner wall of the arc-shaped coaming, wherein each of the two supporting feet (i.e., the first supporting foot and the second supporting foot) is in a shape of an annular strip, an included angle between the adjacent edges of the two supporting feet is 15 degrees to 45 degrees, an annular groove that opens inwards is hollowly formed in the middle edge of the outer arc-shaped edge of each of the two supporting feet, and inner long holes having positioning salient points are formed respectively in adjacent edge parts of the two supporting feet; and a shaft sleeve and a shaft which are provided on both sides of the lower end of the arc-shaped coaming respectively, or a shaft arranged at the outer end on the right side of the first supporting foot and a shaft sleeve arranged at the outer end of the left side of the second supporting foot;

a guiderail main body which is spliced and surrounded sequentially by the plurality of supporting members and is capable of being adapted to the shape of a built-in product, wherein the adjacent supporting members are movably connected through the corresponding shafts and shaft sleeves;

and further comprises a plurality of first adjusting pieces each provided with two short columns, wherein one first adjusting piece is mounted on the adjacent edge parts of the two supporting feet of each supporting member, the two short columns of said first adjusting piece are inserted into the inner long holes in the two supporting feet respectively, and the included angle between the two supporting feet and the radian of the arc-shaped coaming of the supporting member can be adjusted by stirring said first adjusting piece.

The spliced guardrail further comprises a plurality of second adjusting pieces which are mounted on the junction of the adjacent supporting members and used for adjusting the included angle between the outer edges of the adjacent supporting feet of the adjacent supporting members.

Outer long holes having positioning salient points are respectively formed in the outer edge part of each of the first supporting foot and the second supporting foot of each supporting member. Each second adjusting member is provided with a main body and two pins which are arranged on the lower surface of the main body at intervals and is in a state of being mounted on the junction of the adjacent supporting members; the two pins of the second adjusting piece are inserted into the outer long holes in the adjacent supporting feet of the adjacent supporting members respectively.

Each first adjusting piece comprises a strip-shaped main body and two short columns which are arranged on the lower surface of the strip-shaped main body; a center distance of the two short columns is equal to a center distance of the two inner long holes near the upper end of the annular groove.

The first supporting foot and the second supporting foot of each supporting member are arranged symmetrically, and an included angle between the adjacent edges of the first supporting foot and the second supporting foot is 30 degrees to 45 degrees.

The upper end of the coaming of each supporting member is arc-shaped or wavy. The adjacent edge parts of the two supporting feet are preferably lower than the respective upper surface of the corresponding support foot, so as to be adapted to the height of the corresponding first adjusting piece.

Each supporting member, each first adjusting piece and each second adjusting piece are a plastic component respectively. In order to prevent products, such as a flexible fish tank in the guardrail from being scratched and punctured, the intersecting parts of the adjacent surfaces of the supporting members are connected transitionally by a circular arc surface, the intersecting parts of the adjacent surfaces of the first adjusting pieces are connected transitionally by a circular arc surface, and the intersecting parts of the adjacent surfaces of the second adjusting pieces are connected transitionally by a circular arc surface.

The spliced guardrail is circular, elliptical, semi-circular, plum-shaped, polygonal, arc-shaped, V-shaped or U-shaped.

A plastic supporting member for the spliced guardrail comprises an arc-shaped coaming; a first supporting foot and a second supporting foot which extend inwards respectively from two edges of the inner wall of the arc-shaped coaming, wherein each of the two supporting feet is in a shape of an annular strip, an included angle between the adjacent edges of the two supporting feet is 15 degrees to 45 degrees, an annular groove that opens inwards is hollowly formed in the middle edge of the outer arc-shaped edge of each of the two supporting feet, and inner long holes having positioning salient points are formed respectively in adjacent edge parts of the two supporting feet; and a shaft sleeve and a shaft which are provided on both sides of the lower end of the arc-shaped coaming respectively, or a shaft arranged at the outer end on the right side of the first supporting foot and a shaft sleeve arranged at the outer end of the left side of the second supporting foot. The first supporting foot and the second supporting foot of the supporting member are arranged symmetrically, and outer long holes having positioning salient points are respectively formed in the outer edge part of each of the first supporting foot and the second supporting foot.

The spliced guardrail easy to disassemble and assemble of the present invention is mainly spliced sequentially by a plurality of supporting members provided with the adjusting pieces and can be adapted to the shape of the built-in shape. The spliced guardrail may serve as a guardrail for flowers, a product exhibition guardrail or a guardrail for a transparent flexible fish tank, play decoration and protection roles in exhibited products or flowers in the guardrail and play supporting, protection and decoration roles in the flexible fish tank product in the guardrail.

The two supporting feet, which are partially in the shape of an annular strip respectively, of the supporting member are formed by extending from the inner wall of the arc-shaped coaming. The included angle between the adjacent edges of the two supporting feet is 15 degrees to 45 degrees. The annular groove which serves as a preserved deformation space of the arc-shaped coaming is formed in the middle edge of the outer arc-shaped edge of each of the two supporting feet. The included angle can be adjusted by the adapted adjusting pieces to further adjust the radian of the arc-shaped coaming, thereby adapting to the requirements of making guardrails in different shapes.

The supporting member and the adjusting pieces are standard members which can be spliced and assembled into guardrails in various shapes quickly, and are convenient to disassemble, store and transport.

The supporting members and the adjusting pieces are made of anti-UV reinforced plastic which is suitable for outdoor use and can prevent the plastic supporting members from being degraded and aged.

### BRIEF DESCRIPTION OF THE DRAWINGS

FIG. 1 is a stereogram of Embodiment 1 of the spliced guardrail;

FIG. 2 is a schematic diagram of Example 1 of a supporting member in FIG. 1;

FIG. 3 is a schematic diagram of a first adjusting piece in FIG. 1;

FIG. 4 is a stereogram of Embodiment 2 of the spliced guardrail;

FIG. 5 is a locally enlarged view at a circle as shown in FIG. 4;

FIG. 6 is a stereoscope of Embodiment 3 of the spliced guardrail;

FIG. 7 is a locally enlarged view at a circle at the left corner in FIG. 6;

FIG. 8 is a schematic diagram of a second adjusting piece in FIG. 6; and

FIG. 9 is a schematic diagram of Example 2 of the supporting member in FIG. 6.

### DETAILED DESCRIPTION OF THE PREFERRED EMBODIMENTS

The present invention will be described in detail below in conjunction with the embodiments.

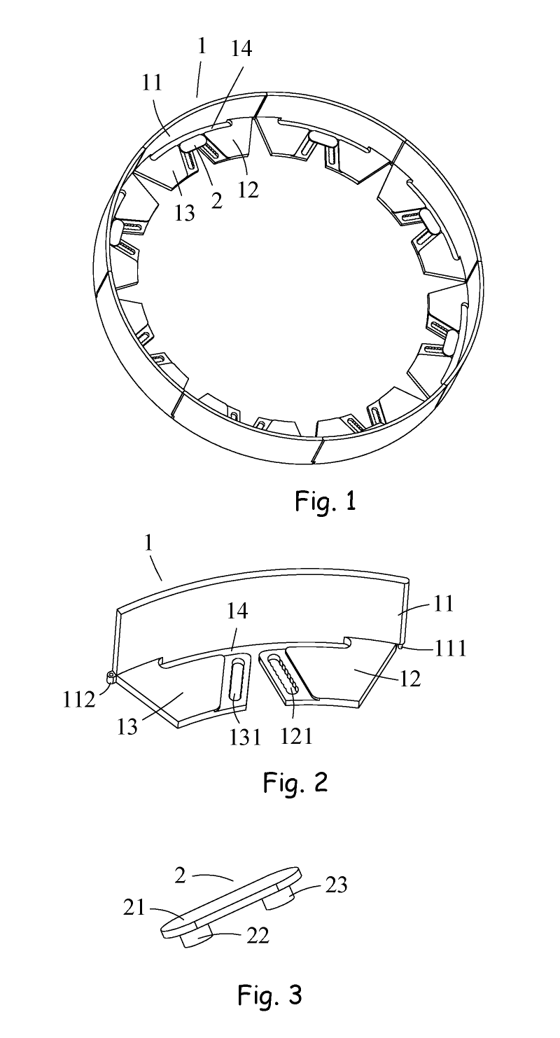

Referring to FIG. 1, a spliced guardrail easy to disassemble and assemble in Embodiment 1 mainly comprises eight supporting members 1 and eight first adjusting pieces 2. The eight supporting members 1 are spliced and surrounded in sequence to form a circular guardrail main body. In addition, the adjacent supporting members are movably connected through corresponding shafts and shaft sleeves.

FIG. 2 is a schematic diagram of Example 1 of each supporting member. The supporting member 1 comprises an arc-shaped coaming 11; a shaft sleeve 112 and a shaft 111 which are arranged on two sides of the lower end of the arc-shaped coaming 11; a first supporting foot 112 and a second supporting foot 13 which extend inwards respectively from two edges of the inner wall of the arc-shaped coaming 11, wherein each of the two supporting feet is in a shape of an annular strip, an annular groove 14 that opens inwards is hollowly formed in the middle edge of the outer arc-shaped edge of each of the two supporting feet, the annular groove serves as a preserved deformation space of the arc-shaped coaming 11, and inner long holes 121, 131 having positioning salient points are formed respectively in adjacent edge parts of the two supporting feet. Each of the two supporting feet is partly in a shape of an annular strip (whose outer arc-shaped edge is larger than the inner arc-shaped edge). An included angle between the adjacent edges of the two supporting feet is 30 degrees. The included angle and the radian of the arc-shaped coaming may be adjusted by the adapted first adjusting piece.

FIG. 3 is a schematic diagram of the first adjusting piece. Each first adjusting piece 2 comprises a strip-shaped main body 21 and two short columns 22, 23 which are arranged on the lower surface of the strip-shaped main body 21. A center distance of the two short columns is equal to a center distance of the two inner long holes 121, 131 near the upper end of the annular groove 14.

As shown in FIG. 1, in the circular guardrail main body, one first adjusting piece 2 is mounted on the adjacent edge parts of the first supporting foot 12 and the second supporting foot 13 of each supporting member 1, two short columns of said first adjusting piece are inserted into the inner long holes 121, 131 in the first supporting foot and the second supporting foot of the corresponding supporting member 1 respectively, and the included angle between the first supporting foot and the second supporting foot can be adjusted by stirring said first adjusting piece along the inner long holes, thereby changing the radian of the arc-shaped coaming 11 of the supporting member.

The adjacent edge parts on each supporting foot in FIG. 2 are lower than the upper surface of the supporting foot, so as to adapted to the height of the strip-shaped main body 21 of the first adjusting piece 2. After the first adjusting piece 2 is mounted, the upper surface thereof is as high as the upper surface of each supporting foot. The positioning salient points arranged on the inner edges of the inner long holes 121, 131 play a locking role in the two short columns 22, 23 of the first adjusting piece 2.

The supporting members 1 (as shown in FIG. 2) in different numbers can be conveniently spliced into guardrails in various shapes, such as a circular shape, an elliptic shape, a semi-circular shape and polygonal shape, which are adapted to PVC flexible fish tanks in various shapes.

In FIG. 1, the first adjusting pieces 2 mounted on the first supporting foot and the second supporting foot of the supporting member 1 are locked on the upper ends (i.e., one ends close to the annular groove 14) of the inner long holes 121, 131, wherein the radian of the arc-shaped coaming 11 is in a maximum design radian. It is necessary to reduce the number of the supporting members 1 if they need to be spliced into a small circular guardrail, and the included angle between the first supporting foot and the second supporting foot of the supporting member 1 is adjusted by the first adjusting piece 2, thereby changing the radian of the arc-shaped coaming 11 conveniently.

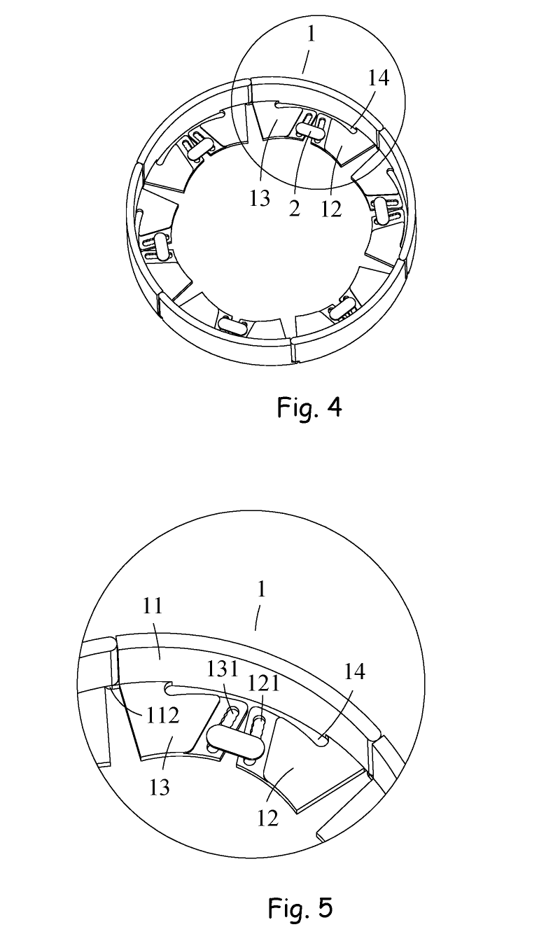

As shown in FIG. 4 and FIG. 5, a spliced guardrail in Embodiment 2 is composed of six supporting members 1 (as shown in FIG. 2) and six first adjusting pieces 2 (as shown in FIG. 3). Each supporting member 1 comprises an arc-shaped coaming 11; a shaft sleeve 112 and a shaft 111 which are arranged on two sides of the lower end of the arc-shaped coaming 11; and a first supporting foot 12 and a second supporting foot 13 which extend inwards respectively from two edges of the inner wall of the arc-shaped coaming 11, wherein an annular groove 14 that opens inwards is hollowly formed in the middle edge of the outer arc-shaped edge of each of the two supporting feet, and inner long holes 121, 131 having positioning salient points are formed respectively in adjacent edge parts of the two supporting feet.

One first adjusting piece 2 (as shown in FIG. 3) is mounted on the adjacent edge parts of the first supporting foot 12 and the second supporting foot 13 of each supporting member 1. The included angle between the first supporting foot and the second supporting foot of the supporting member 1 is reduced by stirring the first adjusting piece 2 to the lower ends of the inner long holes 121, 131 (i.e., one ends away from the annular groove 14) and locking, and meanwhile, the radian of the arc-shaped coaming 11 that is bent inwards is reduced. After the radians of the arc-shaped coamings 11 of the six supporting members 1 are reduced respectively, the arc-shaped coamings 11 are sequentially spliced and surrounded into a circular guardrail having a small diameter. The adjacent supporting members are movably connected through the corresponding shafts 111 and shaft sleeves 112.

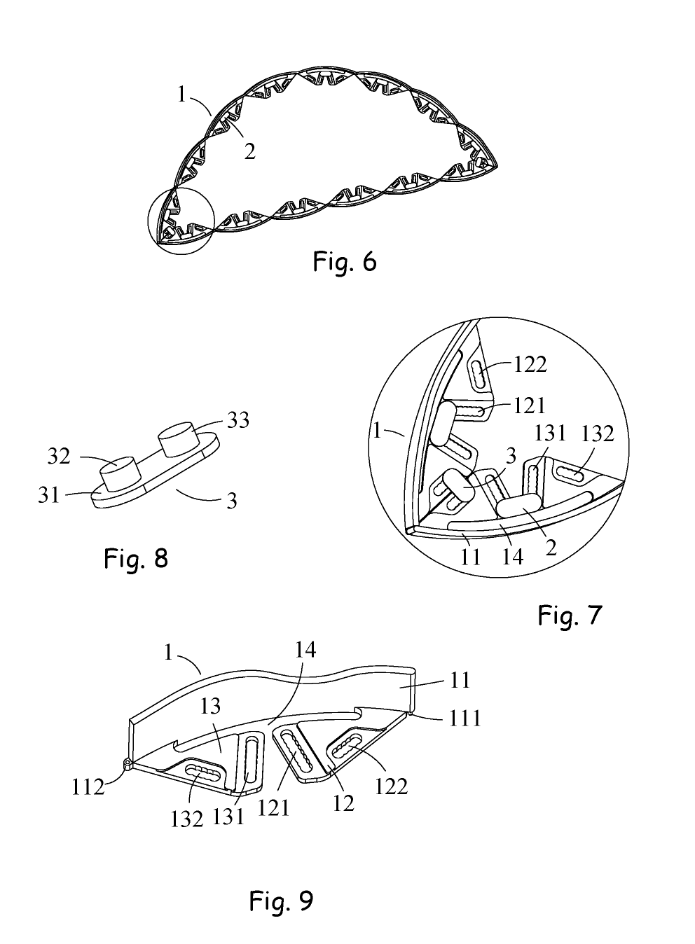

As shown in FIG. 6, a spliced guardrail in Embodiment 3 is a semicircular spliced guardrail which is composed of fourteen supporting members 1, fourteen supporting members 2 and two adjusting pieces 3.

FIG. 8 is a diagram of a second adjusting piece. The second adjusting piece 3 comprises a main body 31 and two pins 32, 33 which are arranged on the lower surface of the main body 31 at intervals.

FIG. 9 is a diagram of Example 2 of the supporting member 1. The supporting member 1 comprises an arc-shaped coaming 11; a shaft sleeve 112 and a shaft 111 which are arranged on two sides of the lower end of the arc-shaped coaming 11; a first supporting foot 112 and a second supporting foot 13 which extend inwards respectively from two edges of the inner wall of the arc-shaped coaming 11. Each of the two supporting feet is in a shape of an annular strip or a trapezoid. An annular groove 14 that opens inwards is hollowly formed in the middle edge of the outer arc-shaped edge of each of the two supporting feet, and an inner long hole 121 and an inner long hole 131 having positioning salient points are formed respectively in adjacent edge parts of the two supporting feet. An outer long hole 122 and an outer long hole 132 having positioning salient points are formed respectively in the outer edge parts of the two supporting feet.

The adjacent edge parts of each supporting foot are lower than the upper surface of the supporting foot, so as to be adapted to the height of the strip-shaped main body of the first adjusting piece. The outer edge part of each supporting foot is also lower than the upper surface of the supporting foot, so as to be adapted to the height of the main body of the second adjusting piece. The upper end of the arc-shaped coaming 11 is wavy. The outer arc-shaped surface of the arc-shaped coaming 11 is provided with decorative patterns, such as stripes.

In FIG. 6, an arc-shaped part of the semicircular spliced guardrail is spliced sequentially by eight supporting members, and an approximately linear part of the semicircular spliced guardrail is spliced sequentially by six supporting members 1. The first adjusting pieces 2 which are mounted on the adjacent edges of the first supporting foot and the second supporting foot of each supporting member 1 are located at the upper ends (one ends close to the annular groove 14) of the inner long holes 121, 131, and the radian of the arc-shaped coaming 11 at this moment is maximum. The supporting members at two ends of the circular arc-shaped part and the approximately linear part are movably connected each other through the corresponding shafts and shaft sleeves. As shown in FIG. 7, the second adjusting pieces 3 are mounted on the adjacent supporting feet of the two supporting members at the corners. Two pins 32, 33 of each second adjusting piece 3 are inserted into the outer long holes 122, 132 in the two adjacent supporting feet respectively, and the second adjusting piece 3 can be stirred along the outer long holes 122, 132. In FIG. 7, the second adjusting piece 3 is stirred in a direction towards the interior of the guardrail is thus locked at one ends, away from the arc-shaped coaming 11, of the outer long holes, such that the adjacent supporting feet of the two adjacent supporting members are combined tightly.

During the implementation of the supporting members as shown in FIG. 2 and FIG. 9, the shaft sleeve and the shaft are arranged on both sides of the lower end of the arc-shaped coaming of the supporting member. The present invention further provides Example 3 of a plastic supporting member. The plastic supporting member in Example 3 is made of anti-UV reinforced plastic. The supporting member comprises an arc-shaped coaming; a first supporting foot and a second supporting foot which extend inwards respectively from two edges of the inner wall of the arc-shaped coaming Each of the two supporting feet is partly in a shape of an annular strip. An annular groove that opens inwards is hollowly formed in the middle edge of the outer arc-shaped edge of each of the two supporting feet, and inner long holes having positioning salient points are formed respectively in adjacent edge parts of the two supporting feet. An included angle between adjacent edges of the two supporting feet is 15 degrees to 45 degrees. The plastic support member further comprises a shaft arranged at the outer end on the right side of the first supporting foot and a shaft sleeve arranged at the outer end on the left side of the second supporting foot.

The first supporting foot and the second supporting foot of the supporting member are symmetrically arranged. Outer long holes having positioning salient points are respectively formed in the outer edge parts of the first supporting foot and the second supporting foot, so as to achieve included angle adjustment and locking of the adjacent supporting members.

The supporting member of the present invention may be designed into standard members in different specifications for selection by customers. The length of the arc-shaped coaming of the supporting member may be 50 mm to 150 mm. The two supporting feet of the supporting member are formed by extending from the inner wall of the arc-shaped coaming. The included angle between the adjacent edges of the two supporting feet is 15 degrees to 45 degrees. The annular groove which serves as a preserved deformation space of the arc-shaped coaming is formed in the middle edge of the outer arc-shaped edge of each of the two supporting feet. The included angle can be adjusted by the adapted adjusting pieces to further adjust the radian of the arc-shaped coaming, thereby adapting to the requirements of making guardrails in different shapes.

The supporting members may be spliced into a circular, elliptical, semicircular, plum-shaped or polygonal guardrail, or into open-type guardrails (fences) in various shapes, such as a U shape, a V shape, a wavy shape, a semicircular shape, an L shape or the like.

What is claimed is:

1. A spliced guardrail easy to disassemble and assemble, comprising:
a plurality of supporting members;
each supporting member comprises an arc-shaped coaming; a first supporting foot and a second supporting foot which extend inwards respectively from two edges of the inner wall of the arc-shaped coaming, wherein each of the two supporting feet is in a shape of an annular strip, an included angle between the adjacent edges of the two supporting feet is 15 degrees to 45 degrees, an annular groove that opens inwards is hollowly formed in the middle edge of the outer arc-shaped edge of each of the two supporting feet, and inner long holes having positioning salient points are formed respectively in adjacent edge parts of the two supporting feet; and a shaft sleeve and a shaft which are provided on both sides of the lower end of the arc-shaped coaming respectively, or a shaft arranged at the outer end on the right side of the first supporting foot and a shaft sleeve arranged at the outer end of the left side of the second supporting foot;
a guiderail main body which is spliced and surrounded sequentially by the plurality of supporting members and is capable of being adapted to the shape of a built-in product, wherein the adjacent supporting members are movably connected through the corresponding shafts and shaft sleeves;
and a plurality of first adjusting pieces each provided with two short columns, wherein one first adjusting piece is mounted on the adjacent edge parts of the two supporting feet of each supporting member, the two short columns of said first adjusting piece are inserted into the inner long holes in the two supporting feet respectively, and the included angle between the two supporting feet and the radian of the arc-shaped coaming of the supporting member can be adjusted by stirring said first adjusting piece.

2. The spliced guardrail according to claim 1, further comprising a plurality of second adjusting pieces which are mounted on the junction of the adjacent supporting members and used for adjusting the included angle between the outer edges of the adjacent supporting feet of the adjacent supporting members.

3. The spliced guardrail according to claim 2, wherein outer long holes having positioning salient points are respectively formed in the outer edge part of each of the first supporting foot and the second supporting foot of each supporting member; each second adjusting member is provided with a main body and two pins which are arranged on the lower surface of the main body at intervals and is in a state of being mounted on the junction of the adjacent supporting members; the two pins of the second adjusting piece are inserted into the outer long holes in the adjacent supporting feet of the adjacent supporting members respectively.

4. The spliced guardrail according to claim 1, wherein each first adjusting piece comprises a strip-shaped main body and two short columns which are arranged on the lower surface of the strip-shaped main body; a center distance of the two short columns is equal to a center distance of the two inner long holes near the upper end of the annular groove.

5. The spliced guardrail according to claim 1, wherein the first supporting foot and the second supporting foot of each supporting member are arranged symmetrically, and the included angle between the adjacent edges of the first supporting foot and the second supporting foot is 30 degrees to 45 degrees.

6. The spliced guardrail according to claim 1, wherein the adjacent edge parts of the two supporting feet are lower than the respective upper surface of the supporting foot, and is used for being adapted to the height of the corresponding first adjusting piece.

7. The spliced guardrail according to claim 1, wherein the upper end of the coaming of each supporting member is arc-shaped or wavy, and the outer surface of the coaming is provided with molded patterns.

8. The spliced guardrail according to claim 1, wherein each supporting member and each first adjusting piece are a plastic component respectively.

9. The spliced guardrail according to claim 1, wherein the spliced guardrail is circular, elliptical, semi-circular, plum-shaped, polygonal, arc-shaped, V-shaped or U-shaped.

10. The spliced guardrail according to claim 2, wherein the spliced guardrail is circular, elliptical, semi-circular, plum-shaped, polygonal, arc-shaped, V-shaped or U-shaped.
